(19) United States
(12) Patent Application Publication
(10) Pub. No.: US 2007/0231542 A1
(43) Pub. Date: Oct. 4, 2007

(54) Articles having low wettability and high light transmission

(75) Inventors: Tao Deng, Clifton Park, NY (US); Judith Stein, Schenectady, NY (US); John Frederick Graf, Ballston Lake, NY (US); Gregory Allen O'Neil, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/395,861

(22) Filed: Apr. 3, 2006

(51) Int. Cl. G11B 5/64

(52) U.S. Cl. 428/141

(57) ABSTRACT

An article comprising a surface portion is provided. The surface portion has a plurality of primary features, and the primary features have a height dimension in the range from about I micron to about 500 microns, an aspect ratio in the range from about 0.5 to about 10, and a spacing dimension in the range from about 0.5 to about 50 feature width units. The surface portion comprising the features has a wettability of the surface sufficient to generate, with a reference fluid, a static contact angle of greater than about 120 degrees and a total transmission of at least about 70% in the visible range of electromagnetic radiation.

### BACKGROUND

This invention relates to surfaces having low liquid wettability and high light transmission. More particularly, this invention relates to surfaces incorporating a texture designed to provide low wettability and high specular transmission. This invention also relates to articles comprising such surfaces, and methods for making such surfaces and articles.

Many applications, such as automotive parts, chemical processing equipment, health care equipment, and textiles, may benefit from surfaces having high resistance to wetting by various fluids. Properly textured surfaces have been demonstrated to increase the resistance of the surface to wetting. These textures tend to interact with light and hence prevent the transmission of the light at the surface. The nontransparent nature of the surfaces makes application of such surfaces problematic in many applications requiring good light transmission. There remains a need for articles with durable surfaces having low liquid wettability and suitable transparency. Moreover, there is a need for simple and versatile methods for making such surfaces and articles having such surfaces.

### SUMMARY OF THE INVENTION

Embodiments of the present invention meet these and other needs by providing a surface that has high light transmission in combination with high resistance to wetting. For example, one embodiment of the invention is an article comprising a surface portion. The surface portion has a plurality of primary features. The primary features have a height dimension in the range from about 1 micron to about 500 microns, an aspect ratio in the range from about 0.5 to about 10, and a spacing dimension in the range from about 0.5 to about 5 feature width units. The surface portion comprising the features has a wettability of the surface sufficient to generate, with a reference fluid, a static contact angle of greater than about 120 degrees and a total transmission of at least about 70% in the visible range of electromagnetic radiation.

Another aspect of the invention is to provide a versatile method to make such surfaces. The method includes the steps of: providing a surface portion; and disposing a plurality of surface features on the surface portion. The primary features have a height dimension in the range from about 1 micron to about 500 microns, an aspect ratio in the range from about 0.5 to about 10, and a spacing dimension in the range from about 0.5 to about 50 feature width units. The surface portion comprising the features has a wettability of the surface sufficient to generate, with a reference fluid, a static contact angle of greater than about 120 degrees and a total transmission of at least about 70% in the visible range of electromagnetic radiation.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 is a schematic of an article having a surface portion with a plurality of features according to one embodiment of the invention;

FIG. 2 is a schematic of transmission of light rays through features with different cross sectional shapes;

FIG. 3 is a schematic of a liquid droplet on a textured surface at Wenzel and at Fakir contacts;

FIG. 4. is a flow chart of method of making an article according to one embodiment of the invention;

FIG. 5. is a schematics of method steps used to make an article, according to one embodiment of the invention;

FIG. 6. is a plot of total transmission and transmission haze vs. refractive index of the material according to one embodiment of the invention;

FIG. 7. is a plot of total transmission and transmission haze vs. spacing dimension of features according to one embodiment of the invention;

FIG. 8 is a plot of total transmission vs. spacing dimension of features according to one embodiment of the invention; and

FIG. 9 is a plot of transmission haze vs. spacing dimension of features according to one embodiment of the invention.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms. Furthermore, whenever a particular feature of the invention is said to comprise or consist of at least one of a number of elements of a group and combinations thereof, it is understood that the feature may comprise or consist of any of the elements of the group, either individually or in combination with any of the other elements of that group.

Superhydrophobic surfaces that are transparent are highly desirable for numerous applications because of their water repellency and self-cleaning properties. Transparent water repellent coatings may be used for obtaining transparent superhydrophobic surfaces. However, such coatings may suffer from poor adhesion to the surface, may lack mechanical robustness, and may be prone to scratches and other defects that detract from transparency. Alternatively, appropriate surface texturing may yield superhydrophobicity. However, surface texturing as conventionally used to promote wetting resistance reduces transparency of the surface drastically. The present inventors have developed a design methodology for creating surface textures having low wettability and at the same time retaining their transparency. Through proper selection of surface feature aspect ratio and spacing dimension, coupled with proper selection of materials based on the application environment (refractive index mismatch between the material and the surrounding environment), a surface can be designed such that the surface is transparent and drops of liquid impinging on the surface exhibit low wettability.

As used herein, feature aspect ratio is the ratio of the median feature height (h) in microns divided by the median feature width (w) in microns. Herein, the median feature spacing dimension (sd) is typically expressed in terms of feature width units. Feature spacing dimension (sd) is the ratio of the median actual feature spacing s (measured between the center points of two neighboring features) to the median feature width (w). For all parameter calculations, the longest edge of the feature structure is taken as the width dimension of the feature.

For understanding the embodiments of the invention, “total transmission”, T represents the amount of incident light that passes through the material, “total reflection” represents the amount of incident light that is reflected from the material, “total absorption” represents the amount of incident light that is absorbed by the material (such that incident light=total transmission+total reflection+total absorption), and “specular transmission”, Tₛ represents the amount of incident light that passes through a material without being scattered and continues on in the same direction as the incident light direction. The “transmission haze” is equal to one hundred times the quantity of the “total transmission” minus the “specular transmission” divided by the “total transmission” amount, 100(T−Tₛ)/T. The term “transparency” means the condition of having “total transmission” of at least about 70% and “transmission haze” of less than about 40%.

The zenith angle in radians is defined as:

$$\text{Zenith Angle} = {Cos}^{- 1} ( \frac{z}{\sqrt{{x}^{2} + {y}^{2} + {z}^{2}}} )$$

where, x,y, and z are the Cartesian coordinates for a given surface (x and y axis are in the plane of the surface and the z-axis is perpendicular to the surface). The zenith angle is used to define the elevation angle of a point projected onto a hemisphere surface. If the point is on the horizon of the hemisphere surface the zenith angle is 90 degrees. If the point is at the top of the hemisphere it has a zenith angle of 0 degrees.

The azimuth angle in radians is defined as:

$$\text{Azimuth Angle} = {Cos}^{- 1} ( \frac{x}{\sqrt{{x}^{2} + {y}^{2}}} ) for y \geq 0$$

$$\text{Azimuth Angle} = 2 π - {Cos}^{- 1} ( \frac{x}{\sqrt{{x}^{2} + {y}^{2}}} ) for y \leq 0$$

The azimuth angle is used to define the facing of a point projected onto a hemisphere surface. The azimuth angle represents the angle of the point with respect to the chosen reference direction defined by the positive x coordinate direction. The azimuth angle is zero degrees pointing in the positive x direction, 90 degrees pointing in the positive y direction, 180 degrees pointing in the negative x direction, and 270 degrees pointing in the negative y direction.

As used herein, the “contact angle” or “static contact angle” is the angle formed between a stationary drop of a reference liquid and a horizontal surface upon which the droplet is disposed, as measured at the liquid/substrate interface. Contact angle is used as a measure of the wettability of the surface. If the liquid spreads completely on the surface and forms a film, the contact angle is 0° C. As the contact angle increases, the wettability decreases. The term “superhydrophobic” is used to describe surfaces having very low wettability for water. As used herein, the term “superhydrophobic” will be understood to refer to a surface that generates a static contact angle with water of greater than about 120 degrees. Because wettability depends in part upon the surface tension of the reference liquid, a given surface may have a different wettability (and hence form a different contact angle) for different liquids. In some embodiments, the liquid is water.

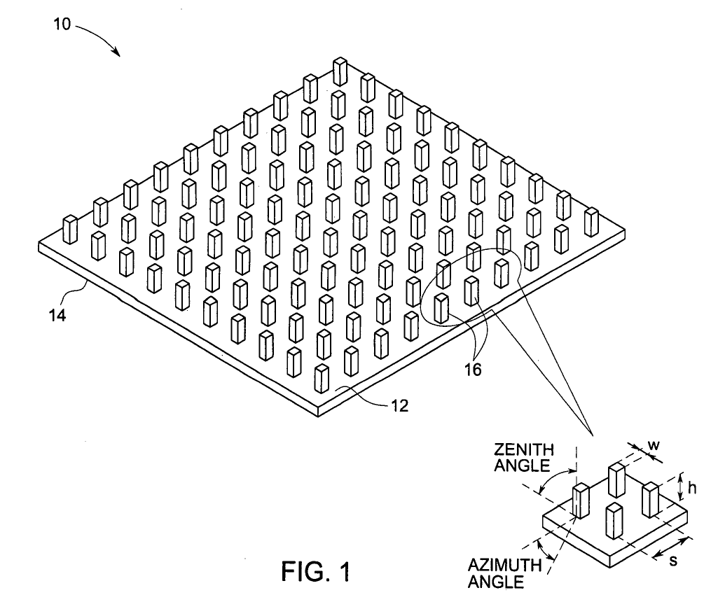

Referring to the drawings in general and to FIG. 1 in particular, it will be understood that the illustrations are for the purpose of describing a particular embodiment of the invention and are not intended to limit the invention thereto. FIG. 1 is a schematic view of a surface of an article according to one embodiment of the present invention. Article 10 comprises a surface portion 12 disposed on a body portion 14. The surface portion 12 has a plurality of primary features 16. Surface portion 12 may comprise the same material as the body portion 14 or may comprise a different material. The surface portion may comprise a coating or a layer of another material. The primary features 16 may comprise the same material as the surface portion 12 or may comprise another material. In certain embodiments, the surface portion 12 may include an additional low energy surface layer (not shown) disposed on the features to further enhance resistance to wetting. The characteristics of the features such as feature width w, feature spacing s, feature height h, and azimuth and zenith angles are marked in FIG. 1.

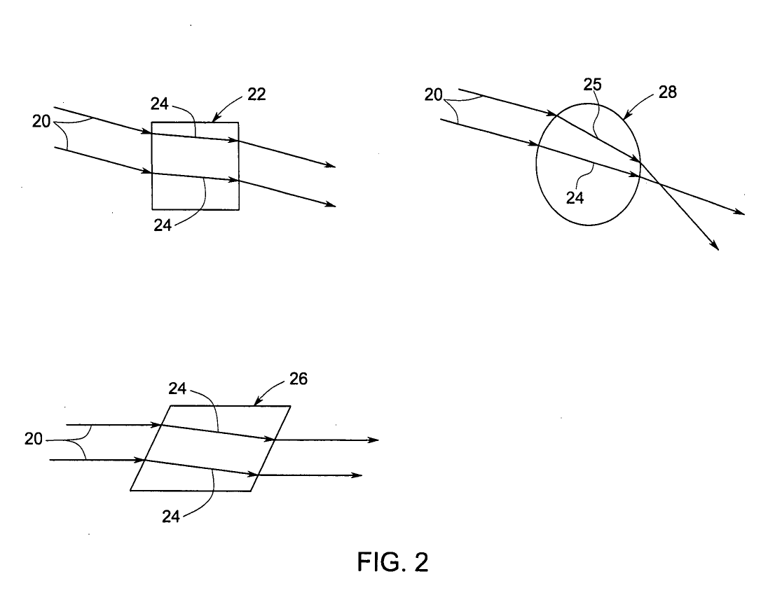

The shape, dimensions, and the spacing of the primary features on the surface all influence both the transmission of light through the surface and the contact angle of a fluid droplet on the surface. The inventors have discovered that it is possible to increase the wetting resistance significantly and retain the transparency of the article by providing feature structures at the surface portion of the article, such that the cross sectional shape of the structure as projected on a plane parallel to the surface portion of the article has opposite faces parallel to each other. Examples of such shapes are parallelograms, rectangles, and squares. One skilled in the art will appreciate that insubstantial deviations from parallel may be tolerated and can be considered “parallel” if they do not substantially detract (that is, render the final product unfit for use in a particular application) from transmission performance relative to that expected for perfectly parallel surfaces. FIG. 2 shows the transmission of a light beam through feature structures having different cross sectional shapes. When light rays 20 are refracted from a surface feature having the cross sectional shape of a rectangle 22 or a parallelogram 26, the refracted light rays 24 travel along the same direction as the incident light rays and hence scattering and transmission haze is minimized. When the cross section shape is a circle 28, the refracted light rays 24 and 25 may travel in directions different from the direction of the incident light rays and hence lead to significant scattering and light transmission haze. Accordingly, in certain embodiments, the primary features have a cross sectional shape of a parallelogram, as projected on a plane parallel to the surface portion of the article. In some embodiments, each of the primary features have the cross sectional shape of a rectangle. In other embodiments, the primary features have the cross sectional shape of a square. Tapering of feature structures (from the bottom surface to the top surface of the structures) may lead to additional light transmission haze, though slight tapering of structures leading to slightly non-parallel surfaces is tolerable as discussed above. Surface features having their bottom and top surfaces parallel to each other advantageously increases light transmission through the surface and also generates less scattering and transmission haze.

In some embodiments, the material and feature dimensions are desirably configured to maximize both the wetting resistance and the light transmission and minimize the transmission haze. The effect of geometric parameters on surface wetting resistance is calculated using an energy balance analysis. Parameters such as feature height, aspect ratio, and spacing have been shown to significantly affect the wetting behavior of liquid droplets on a surface.

The basic effect of surface roughness can be easily understood by the Wenzel equation, which relates the apparent contact angle θ_{w} of a drop on a rough surface with roughness r>1. Here, r is the ratio of total surface area to the total projected surface area, and can be related to Young's intrinsic contact angle θᵢ by the following equation:
cos θ_{w}=r cos θᵢ (1)

The apparent contact angle of a sessile droplet varies not only with physical texture or the roughness but also with the chemical texture determined by the composition of the solid surface. Consider a chemically heterogeneous surface made up of two different chemical species characterized by their intrinsic contact angles θ_{i,1} and θ_{i,2,} respectively. The individual feature areas are assumed to be much smaller than the drop size and let φ₁ and φ₂ be the area fraction of each of the species (φ₁+φ₂=1). The apparent contact angle in this case is named after Cassie-Baxter and is given by the equation as follows:
cos θ_{cb}=φ₁ cos θ_{i,1}+φ₂ cos θ_{i,2} (2)

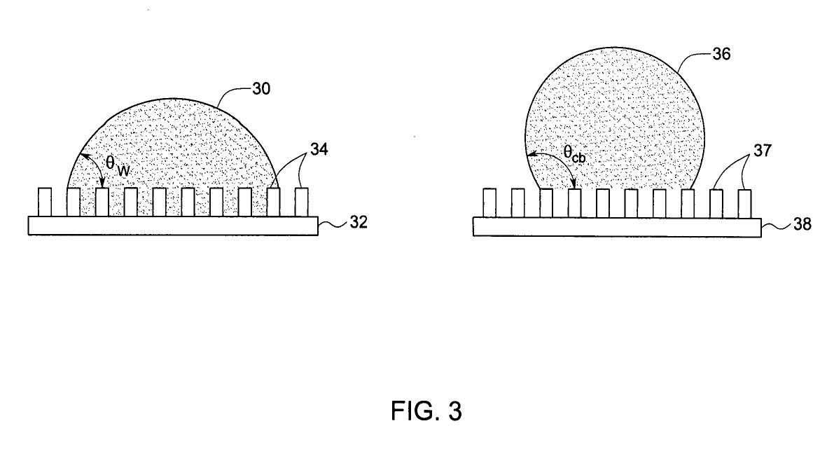

A droplet can sit on a solid surface in two distinct configurations or states as shown in FIG. 3. The droplet 30 is said to be in Wenzel state when it is conformal with the topography of the surface 32 having features 34. Wenzel's equation (equation 1) explained earlier is used to compute the apparent contact angle. The other state in which a droplet 36 can rest on the surface is called the Fakir state, where it is not conformal with the topography and only touches the tops of the protrusions 37 on the surface 38. This leads to the formation of a composite surface with trapped air pockets. The Cassie-Baxter relationship from equation 2 is therefore employed to determine the apparent contact angle in the Fakir state. The solid surface has an area fraction of φ and an intrinsic contact angle of θᵢ; the freely suspended fraction contacting air has an area fraction of (1−φ) and a contact angle of 180°. Substituting the values, the apparent contact angle in the Fakir state is readily computed as
cos θ_{cb}=φ(cos θ_{i,}+1)−1 (3)

The Fakir or the air-pocket state is stable if the following inequality holds true:
cos θ_{i,}<(φ−1)/(r−φ) (4)

For a given material, thus having fixed θᵢ, this state could be stable or “metastable” depending on the choice of the parameters r and φ. Here, metastable and stable are analogous to local and global energy minima; but clearly very distinct from them. While a local and a global minimum, if they are distinct, have different locations in space, a stable and a metastable state correspond to two different energy levels at the same location; metastable corresponding to the higher energy level. So when a droplet is in Fakir state and the Wenzel state at that location in space has a lower energy, then the Fakir state is the metastable state while the Wenzel state is the stable state. The reason why a droplet does not spontaneously transit to the lower energy Wenzel state is because of the presence of an energy barrier; analogous to the activation energy of a reaction that prevents spontaneous conversion to products. The energy barrier thus accounts for the meta-stability and is easily estimated. It gives a useful bound on the energy that needs to be coupled to the droplet before one risks its transition to the stable Wenzel state. For a set of given surface feature dimensions apparent contact angle may be calculated by the Cassie-Baxter equation for the Fakir state described earlier.

From the above discussion it is clear that the contact angle made by the liquid droplet on a textured surface depends on the surface energy, feature dimensions, and feature spacings. Moreover, the parameters relating to feature dimensions and spacing, along with certain optical properties, such as refractive index, also have been shown to significantly affect the light transmission capability of the surface. Examples of the effects measured for the various parameters are presented below. The surface texture regimes described herein have been developed by combining these analyses in an effort to obtain suitably high levels of light transmission and wetting resistance.

Typically, the light transmission and contact angle increases and the transmission haze decreases to some extent with increase in spacing dimension, however, the magnitude of increase depends on the aspect ratio, height, and width of the features. Accordingly, in certain embodiments, the median height dimension h is in the range from about 1 micron to about 500 microns. In other embodiments, h is in the range from about 10 microns to about 100 microns. In other embodiments, h is in the range from about 10 microns to about 50 microns. In certain embodiments, the median aspect ratio of the features is in the range of 0.5 to about 10. In other embodiments, the median feature aspect ratio is in the range from about 1 to about 5. In other embodiments, the feature aspect ratio is in the range from about 1 to about 3. In certain embodiments, the median spacing dimension (sd) is in the range from about 0.5 to about 50 feature width units. In other embodiments, sd is in the range from about 0.5 to about 5 feature width units. In one embodiment, sd is in the range from about 3 to about 5 feature width units. The specific dimensions and spacings of the features are chosen based on the desired value of optical transparency and wettability.

The refractive index of the material making up the surface features also plays a role in determining the optical performance of the article. In some embodiments, the refractive index of the material of the surface features is in the range from about 1.3 to about 2. In other embodiments, the refractive index of the material of the surface features is in the range from about 1.3 to about 1.7.

Where the parameters of height, width, aspect ratio, and spacing dimension are used herein, as above, to characterize a plurality of surface features, it will be appreciated that the parameters being referenced are median values characteristic of the population of surface features. Furthermore, embodiments of the present invention extend to embrace surfaces comprising a multi-modal distribution in any one or more of the parameters, as where, for instance, the plurality of surface features comprises a bimodal distribution in feature spacing, or where the plurality of surface features comprises more than one population of feature shape.

In some embodiments, the primary features comprise a polymer. In certain embodiments, the polymer comprises a hydrophobic polymer. In other embodiments, the polymer is a hydrophilic polymer. Examples of hydrophobic polymers include, but are not limited to, silicones, polyolefins such as polypropylene or polyethylene, polyacrylamides, silicone-modified polycarbonates, fluoro-modified polycarbonate, hydrophobic non-BPA polycarbonate, polystyrenes, polyesters (e.g. PBT or PET), polyester carbonate, polyphenylene sulphide, polyvinyl chloride, polyurethanes, acrylates, and fluoropolymers. Suitable examples of polyolefins are polypropylene and polyethylene. As used herein, “polycarbonate” implies bisphenol-A-polycarbonate (BPA-PC), “silicone-modified polycarbonate” implies copolymers of BPA-PC and silicone (graft, block, endcapped or otherwise), “fluoro-modified polycarbonate” implies BPA-PC with fluoro groups somewhere on the chain (encap or off the main chain), “hydrophobic non-BPA polycarbonate” implies any polycarbonate made substantially from monomers other than BPA-that has a water contact angle greater than 90 degrees (a specific example being certain aliphatic polycarbonates). Also suitable are thermoplastic elastomers. In some embodiments, the polymer is a copolymer. The polymer may be a random copolymer, a block copolymer, or a graft copolymer. A block copolymer may be a diblock copolymer, a triblock copolymer, or a multiblock copolymer. In other embodiments, the polymer is a blend or a mixture of more than one polymer with or without an additive. Some suitable copolymers are ethylene-vinyl acetate copolymer, ethylene-butyl acrylate copolymer, acrylic acid-ethylene copolymer, ethylene-vinyl carbozole copolymer, ethylene-propylene-block copolymer, polybutylenes, polymethylpentenes, polyisobutylene, acrylonitrile butadiene styrene terpolymers, polyisoprenes, methyl-butylene copolymers, isoprene isobutylene copolymers. Also suitable are liquid crystalline polymers. In an exemplary embodiment, the hydrophobic polymer comprises silicone. In a further exemplary embodiment, the polymer comprises a copolymer of polycarbonate and silicone. In one embodiment, the polymer comprises a polycarbonate having fluoro-endcaps.

The embodiments of the invention enable the formation of a transparent, wetting-resistant surface, even using materials that ordinarily are mildly hydrophilic. As used herein, a “mildly hydrophilic” material is one having a contact angle with water of at least about 70 degrees. In certain applications, the primary features comprise a mildly hydrophilic polymer. In such embodiments, the surface feature sizes, shape, spacing dimension, and the refractive index mismatch between the material and the surrounding media are adjusted to achieve a desirable combination of wetting resistance and transparency. Non-limiting examples of polymers that in certain cases may be mildly hydrophilic include, but are not limited to, polyimide, polysilazane, polyacrylate, polyurethane, epoxy, polyetherimide, polycarbonate, polymethyl methacrylate, polyamides, polyether ether ketones, and polysulfone. In certain embodiments, the polymer may be a blend of more than one polymer. In some embodiments, the polymer may include a copolymer. A block copolymer may be a diblock copolymer, a triblock copolymer, or a multiblock copolymer.

Also suitable for use are graft copolymers. Some suitable examples of graft copolymers include, but are not limited to, copolymers consiting of styrene and/or acrylonitrile and/or alkyl (meth)acrylic acid alkyl esters grafted onto polybutadienes, butadiene-styrene copolymers and acrylic rubbers. In an exemplary embodiment, the copolymer comprises a graft copolymer of silicone grafted onto polycarbonate. The graft copolymers may be prepared by any known processes, such as, for example, bulk, suspension, emulsion or bulk-suspension processes.

In some embodiments, the primary features comprise a ceramic. Alternatively, the ceramic may be in the form of a layer disposed on the surface portion. The ceramic may comprise an oxide, a carbide, a nitride, a fluoride, a selenide, a telluride, a sulphide, a boride, or an oxynitride, or any combination of these ceramics. The examples of suitable ceramics include, but are not limited to, oxides of zirconium, titanium, tantalum, aluminum, hafnium, silicon, indium, tin, yttrium, or cerium, fluorides of lanthanum, magnesium, calcium, lithium, yttrium, barium, lead, neodymium, or aluminum, carbides of silicon or tungsten, sulphides of zinc or cadmium, selenides and tellurides of germanium or silicon, nitrides of boron, titanium, silicon, or titanium, stibinite (SbS₂), titanium oxynitride, or combinations thereof. The choice of the material is generally made so as to avoid unwanted optical effects such as absorption, color casts (by absorption or interference), and reflections. On the other hand, it is also desirable in some applications to choose materials that give specific colors/properties to the structures. The specific material selected in such cases will depend on the desired properties of the article and will be apparent to those knowledgeable in the art.

In some embodiments, the primary features comprise a glass. Examples of suitable glasses include, but are not limited to, modified silicate and borosilicate glasses. In one embodiment, the glass comprises an alkaline earth-alkali silicate glass based on calcium oxide, sodium oxide, silicon oxide, and/or aluminum oxide. In another embodiment, the glass comprises borosilicate glass based on silicon dioxide, aluminum oxide, alkaline earth metal oxides, boric oxide, sodium oxide, and potassium oxide. The specific glass material selected depends on the desired properties of the article and will be apparent to those knowledgeable in the art.

In certain embodiments, it may be desirable to have the surface transparent, hydrophobic and electrically conducting-for example, to control the fluid movement with an electric field as in microfluidic devices or in anti-icing systems on aircraft wings, where an electric field need be applied to reduce or eliminate the electrostatic forces that bond ice and water to the surface. In such embodiments, the surface portion comprises a metal layer. The metal layer may also act as a protective layer in certain applications. The examples of suitable metals include, but are not limited to, gold and silver. In such embodiments, the thickness of the metal layer is so as not to substantially hinder the optical transmission. In one embodiment, the metal layer thickness is less than about 200 nanometers. In another embodiment, the metal layer thickness is less than about 100 nanometers.

In certain embodiments, the surface portion may comprise a composite such as a ceramic-ceramic composite, a glass-ceramic composite, a polymer-polymer composite, or a polymer-ceramic composite. The material of the feature structures is chosen so as to optimize the refractive index mismatch between the material and the surrounding environment, as a large mismatch in the refractive index between the material and the surrounding environment may lead to undue scattering of the light and hence a decrease in the transmission of light through the surface. Other examples of materials having suitable optical and mechanical properties for use as primary features will be apparent to those skilled in the art.

In certain embodiments, primary features further comprise a plurality of secondary features disposed on the primary features, in order to further increase the wetting resistance. Accordingly, in one embodiment at least one primary feature comprises a plurality of secondary features. In another embodiment, substantial amount of primary features comprise a plurality of secondary features. In yet another embodiment, almost all of the primary features comprise a plurality of secondary features. In such embodiments, the dimensions of the secondary features are such that they do not substantially absorb, scatter, or otherwise impede light passing through the surface. Accordingly, the secondary features have a largest dimension of less than about 300 nanometers. In one embodiment, the secondary features have a dimension of less than about 200 nanometers. In another embodiment, the secondary features have a dimension in the range from about 100 nanometers to about 150 nanometers. The secondary features may comprise the same material as the primary features or may comprise another material. The secondary features may comprise a polymer, or a ceramic, or a metal. The secondary features may include any hydrophobic or a hydrophilic polymer, any ceramic, or a metal listed in the above embodiments. The choice of the material is generally made to avoid unwanted optical effects such as absorption, color casts (by absorption or interference), and reflections. On the other hand, it is also desirable in some applications to choose materials that give specific colors to the structures. The specific material selected in such cases will depend on the desired properties of the article and will be apparent to those knowledgeable in the art.

In certain embodiments, the surface portion further comprises a surface energy modification layer to further increase the wetting resistance of the surface. The surface energy modification layer may comprise a coating disposed over the features. The coating comprises a hydrophobic hard coat, a fluorinated non-polymeric material, or a polymer. Diamond-like carbon (DLC) coatings, which typically have high wear resistance, have been applied to improve resistance to wetting (see, for example, U.S. Pat. No. 6,623,241). Other hard coatings such as nitrides or oxides, such as tantalum oxide, may also serve this purpose. These hardcoatings, and methods for applying them (CVD, PVD, etc.), are known in the art, and may be of particular use in harsh environments. Fluorinated, non-polymeric materials, such as fluorosilanes, are also suitable coating materials that exhibit low wettability for certain liquids, including water. The coating may also include apolar moieties, such as methyl, or trifluoromethyl groups. The coating may comprise a polymeric material. Examples of polymeric materials known to have advantageous resistance to wetting by certain liquids include silicones, fluoropolymers, urethanes, acrylates, epoxies, polysilazanes, aliphatic hydrocarbons, polyimides, polycarbonates, polyether imides, polystyrenes, polyolefins, polypropylenes, polyethylenes or mixtures thereof. Alternatively, the surface modification layer may be formed by diffusing or implanting molecular, atomic, or ionic species into the surface portion to form a layer of material having altered surface properties compared to material underneath the surface modification layer. The choice of the surface modification layer is generally made to avoid unwanted optical effects such as absorption, color casts (by absorption or interference), and reflections. On the other hand, it is also desirable in some applications to choose materials that give specific colors, or specific properties, for example scratch resistance or wear resistant properties to the structures. The specific coating/layer selected in such cases will depend on the desired properties of the article and will be apparent to those knowledgeable in the art.

Certain embodiments of the invention facilitate design and fabrication of a surface region of an article to obtain desired wetting properties and light transmission depending on the end-use application. In some embodiments, the feature shape, dimensions, and spacing dimensions are designed so that both the wetting resistance and light transmission are maximized, and transmission haze is minimized, to obtain a transparent superhydrophobic surface. In other embodiments, the feature dimensions are chosen so that the wetting resistance is reasonably high (as in, for example, a hydrophobic material) to obtain a self-cleaning surface, and at the same time the light transmission is optimized to make the surface region transparent. In other embodiments, the surface features are chosen so that the light transmission is maximized to make the surface region transparent.

Wetting resistance is commonly quantified by measuring the contact angle generated between a static droplet of liquid and a surface of interest, upon which the droplet is placed. The material and the feature dimensions (aspect ratio and feature height) are the key parameters in controlling the contact angle. As resistance to wetting increases, the contact angle measurement approaches 180 degrees. In certain embodiments, surface portion 12 comprising the features 16 has a wettability of the surface sufficient to generate, with a reference fluid, a static contact angle of greater than about 120 degrees. In other embodiments, the surface portion comprising the features has a wettability of the surface sufficient to generate, with a reference fluid, a static contact angle of greater than about 140 degrees.

The primary feature shape, the aspect ratio, and the refractive index mismatch between the material and the space between the features dictate the light transmission though the surface. In certain embodiments, the surface portion comprising the features has a total light transmission of at least about 70% in the visible range of electromagnetic radiation. In other embodiments, the surface portion comprising the features has a total light transmission of at least about 75% in the visible range of electromagnetic radiation. In certain embodiments, the surface portion comprising the features has a light transmission haze less than about 40% in the visible range of electromagnetic radiation. In other embodiments, the surface portion comprising the features has a light transmission haze less than about 15% in the visible range of electromagnetic radiation.

Articles with controlled wettability and light transmission are attractive for many applications. The advantages of such surfaces could be utilized in making surfaces that are transparent and also superhydrophobic, self-cleaning, biocompatible, or wear resistant. Examples of potential applications of embodiments of the present invention include laboratory vessels, windows and windshields, vehicular surfaces, out door furniture, household goods such as bottles and containers, visual signaling devices, video displays, greenhouses, stadium roofs, green-house roofs, and marine vessels. Biotechnological applications include membrane separation, anti-bacterial surfaces, micro-fluidic channels, etc. Other exemplary articles include, but are not limited to, airfoils or hydrofoils, pipes and tubing for liquid transport or protein separation columns. Articles with surface features as described in the above embodiments are especially attractive for applications where transparency is desirable. Such articles may include window panes, windshields, display screens, mirrors, medical devices, transparent coatings for auto, aero or other body panels, and easy-to-clean walls and countertops.

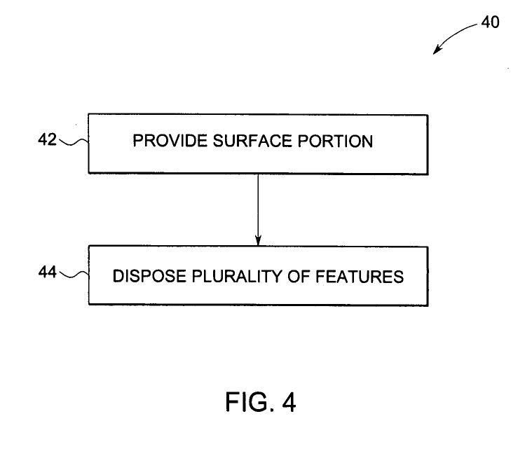

In some embodiments, a method of making an article is provided. The method 40, given as a flow diagram in FIG. 4, includes the steps of: providing a surface portion in step 42; and disposing a plurality of surface features on the surface portion in step 44, wherein the plurality of features have a height dimension in the range from about 1 micron to about 500 microns, an aspect ratio in the range from about 0.5 to about 10, and a spacing dimension in the range from about 0.5 to about 5 feature width units.

Any surface texturing method known in the art may be used to dispose surface features having the characteristics noted above. In some embodiments, features 16 are fabricated directly on surface portion 12 of article 10. For example by starting with a bulk polymer structure, the surface features may be formed by a soft lithography technique. In other embodiments, features 16 are fabricated separately from body portion 14 and then disposed onto body portion 14 at surface portion 12. Disposition of features 16 onto body portion 14 can be done by individually attaching features 16, or the features may be disposed on a sheet, foil or other suitable medium that is then attached to the body portion 14. Attachment in either case may be accomplished through any appropriate method, such as, but not limited to, welding, brazing, mechanically attaching, or adhesively attaching via epoxy or other adhesive.

The disposition of features 16 may be accomplished by disposing material onto the surface of the article, by removing material from the surface, or a combination of both depositing and removing. Many methods are known in the art for adding or removing material from a surface to form ordered arrays of features. Examples of suitable surface texturing methods include, but are not limited to, replication, embossing, electroforming, spray process, etching, and deposition. The particular method used depends on the material to be disposed, and the feature dimensions.

Soft lithography is an efficient means of fabricating ordered arrays of features with high aspect ratio on polymer surfaces. Soft lithography is a microfabrication process in which a soft polymer, such as poly(dimethylsiloxane) or other elastomer, is cast on a mold that contains a microfabricated relief or engraved pattern. The liquid polymer is poured over the mold and allowed to cure until it is crosslinked. After crosslinking, the polymer is peeled off the mold, and the surface of the polymer that was in contact with the mold is left with an imprint of the mold topography. The molds used for casting the polymer are usually made of plain silicon wafers on which a photoresist pattern has been created using a conventional photolithographic process. Examples of soft lithographic techniques include microcontact printing, microtransfer patterning, replica molding and liquid embossing. Ordered arrays of features can be provided by these methods easily; the lower limit of feature size available through these techniques is limited by the resolution of the particular lithographic process being applied.

Direct write deposition is a cost-effective process with the capability to create a variety of nano-and micro-scale features. As is known in the art, direct write deposition technologies are used for many purposes, including writing circuitry on circuit boards. Direct write deposition involves the preparation of a slurry or “ink” including a powder of the material to be deposited. A dispensing system deposits the ink in a very controlled manner onto a substrate, which is then aged, hardened, and/or sintered. Direct write deposition may be used to form three-dimensional objects by dispensing and hardening successive layers of the object. Examples of known direct write technologies include dip pen lithography, micropen or nozzle systems, laser particle guidance systems, plasma spray, laser assisted chemical vapor deposition, ink jet printing, and transfer printing, any of which may be adapted for use to fabricate features in accordance with embodiments of the present invention.

In other embodiments, features are formed by providing a material, such as a polymer blend, or a glass, where the material comprises a plurality of phases, and selectively etching the material to remove at least one phase while exposing the remaining phases. For example, diblock copolymers when processed under suitable conditions are known to give ordered structures comprising multiple phases. In certain cases one or more of the phases can be etched preferentially to form a textured surface.

As another example, a glass, metal, or polymer having constituent phases known to be immiscible at ambient temperatures but miscible at elevated temperatures is provided at a temperature sufficiently high to allow the constituents to homogenize, then is cooled at a rate sufficient to allow for the constituent phases to separate to form nano-scale features. One of the phases is then selectively etched to expose features made of the remaining phase. In one embodiment, the starting material is disposed as a coating on body portion prior to effecting the phase separation. Moreover, in certain embodiments, a body portion is provided with micro-scale features by etching, machining, or other suitable process prior to receiving the starting material; after the phase separation is effected and nano-scale features are exposed, the resultant article will have primary micro-scale features upon which are disposed nano-scale secondary features.

In some embodiments, article 10 further comprises a surface modification layer (not shown) disposed on surface portion 12. This layer is formed, in one embodiment, by overlaying a layer of material at surface portion 12, resulting in a coating disposed over features 16. These layers may be deposited by any known technique in the art including, chemical or physical vapor deposition, spraying, and plasma deposition. Alternatively, the surface modification layer may be formed by diffusing or implanting molecular, atomic, or ionic species into the surface portion 120 to form a layer of material having altered surface properties compared to material underneath the surface modification layer. Ion implantation of metallic materials with ions of nitrogen (N), fluorine (F), carbon (C), oxygen (O), helium (He), argon (Ar), or hydrogen (H) may lower the surface energy (and hence the wettability) of the implanted material.

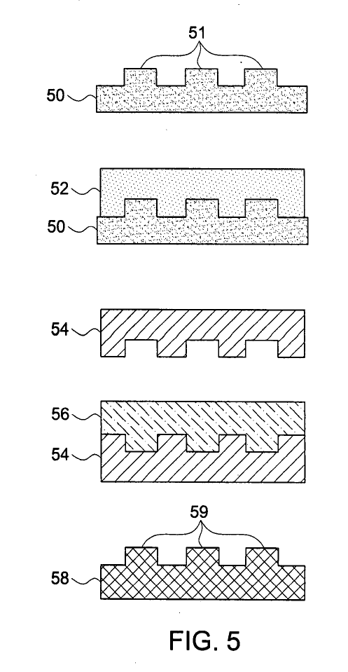

Disposing surface features on the surface portion of an article by replication is shown as a schematic in FIG. 5. A replication process typically involves depicting the topography of an object. In principle, a replica of a surface can be negative one (or direct) alternatively a positive, and consequently a two-step replica. Ideally, in the first step of replication, the material should have a fluid character, so as to fill out the slightest details of the mold. In an exemplary process of this type, a master structure 50 with desired surface features 51 is fabricated into silicon using photolithography. The master silicon 50 surface may be coated with a thin coating of fluorosilane before the replication. Then a precursor 52, such as polydimethylsiloxane (PDMS, silicone), is poured on top of the silicon master surface and cured to solidify the polymer. The cured negative replica 54 may be peeled off from the master surface and molded into another polymer substrate 56 to make a positive replica with surface features 59 identical to those of master structure 50. Thus silicone articles 58 with desired surface features may be fabricated.

The embodiments of the present invention are fundamentally different from those conventionally known in the art. There have been reports of superhydrophobic surfaces with various degree of light transmission by making the texture sizes less than about 300 nm. As it is well known that the light transmission though a surface reduces drastically on increasing the feature sizes above the wavelength of light, most of the efforts on transparent superhydrophobic surfaces are directed towards making surface features sized much below the wavelength of light. In contrast, articles according to the embodiments of the present invention have micron-sized surface features with optimized dimensions. Fabrication of micron-sized features typically is less cumbersome than fabrication of nano-sized features. These micron-sized features may be fabricated easily, for example, by soft lithographic techniques.

In addition, many conventional methods for producing superhydrophobic surfaces are based on hydrophobic coatings. The methods based on such coatings often have adhesion-related issues. They also may have the problem of short lifetime of coated articles, as the coatings degrade with time. The embodiments of the invention described above achieve significant gains in wetting resistance over uncoated, texture-free surfaces, without the limitations associated with prime dependency on a coating system.

The following example serves to illustrate the features and advantages offered by the present invention, and are not intended to limit the invention thereto.

### EXAMPLE 1

### Making polydimethylsiloxane superhydrophobic and Transparent Articles

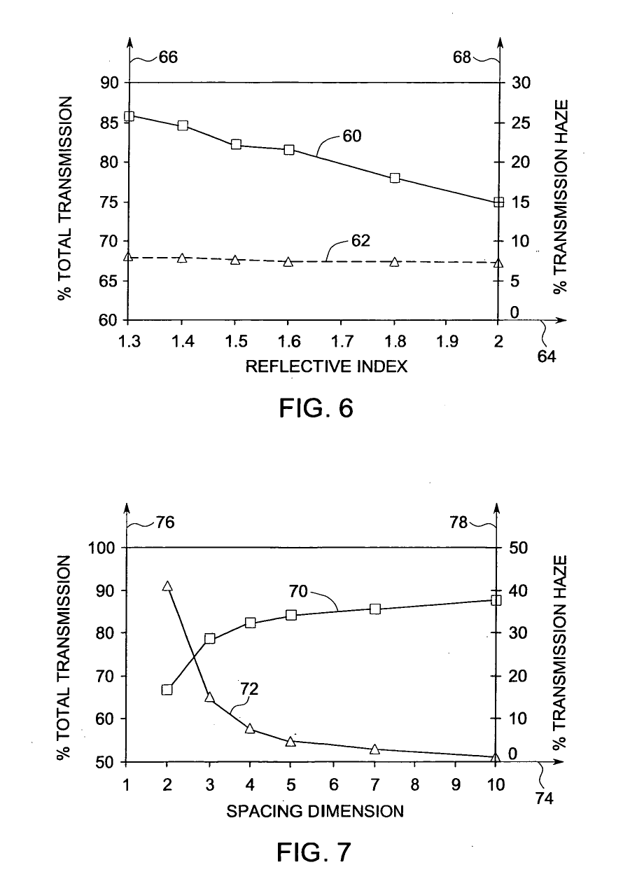

Silicone posts were fabricated using microreplication, a soft lithography process. A clean piece of silicon substrate was provided. The master structure was fabricated into silicon using photolithography. The master silicon surface was coated with a thin coating of fluorosilane before the replication. Then a polydimethylsiloxane (PDMS, silicone) precursor, was poured on top of the silicon master surface and cured at 60° C. for 2 hours. The cured silicone negative replica was peeled off from the master surface and molded into another polymer to make a positive replica having surface features identical to those on the master. In this study, the material used for the 2nd replica was also silicone. Both light and water interaction with such replicated silicone surfaces were investigated. With water as the reference fluid, the contact angle was measured. For measuring the contact angle, the water droplet was freed from the delivering device after the contact with the surface. An optical image of the water droplet on the surface was taken and analyzed to obtain the contact angle. Percentage of total light transmission and percentage of transmission haze were calculated using a geometric ray tracing program. Features with different height, width, and spacing dimensions were fabricated and the data are included in Tables 1, 2 and FIGS. 6-9.

Table 1 summarizes the water contact angle and the light transmission in the middle visible region (550 nm) for features with height dimension of 10 microns. The material had a refractive index of 1.5 and the visible light had a wavelength of 550 nm. The contact angle slightly increased when the spacing increased. The results fit well with the Cassie-Baxter equation (3). As the aspect ratio increased, the contact angle increased. The table also shows the light transmission through different regions at 550 nm. It shows that light transmission increased as the spacing dimension increased, and in some embodiments the transmission reached as high as 90%.

TABLE 1

| Feature width | Feature spacing | | Light Transmission |
|---|---|---|---|
| (micron) | (micron) | Contact angle (°) | (at 550 nm) % |
| 5 | 10 | 154 | 44 |
| 5 | 15 | 157 | 65 |
| 5 | 20 | 163 | 80 |
| 10 | 20 | 154 | 60 |
| 10 | 30 | 156 | 87 |
| 10 | 40 | 159 | 89 |
| 15 | 5 | 145 | 34 |
| 15 | 15 | 147 | 50 |
| 15 | 30 | 153 | 83 |
| 15 | 45 | 156 | 91 |

Table 2 indicates the change in total transmission and transmission haze by changing the zenith and azimuth angle of the sample measurement orientation for a material with square features that have a height of 10 microns, an aspect ratio=1, and a spacing dimension of 4 feature width units. The material had a refractive index of 1.5 and the visible light had a wavelength of 550 nm.

TABLE 2

| | | | Light |
|---|---|---|---|
| | | Total Light | Transmission |
| Zenith angle (°) | Azimuth angle (°) | Transmission (%) | Haze (%) |
| 0 | 0 | 92 | 1.2 |
| 30 | 0 | 90.6 | 2.4 |
| 45 | 0 | 87.7 | 3.4 |
| 45 | 45 | 82.3 | 7.7 |

From Table 2, it is clear that the total transmission and transmission haze depends upon the orientation of the observer and the material. The orientation that has the highest haze and lowest transmission was at 45 degree zenith and 45 degree azimuth. Since it is desirable to achieve high transmission and low transmission haze under all observer view orientations, this data shows that it is important to measure and report the total transmission and transmission haze under the worst view conditions. The worst view angle being 45 degrees zenith and 45 degrees azimuth, all of the data reported herein are measured under this condition. FIG. 6 represents the change in total light transmission (plot 60) and light transmission haze (plot 62) by changing the refractive index of the material for square features that have a height greater than or equal to 10 microns, an aspect ratio=1, and a spacing dimension of 4 for visible light with a wavelength of 550 nanometers. In the particular example, the feature height was 10 microns and feature spacing was 40 microns. Sample measurement orientation was at 45 degrees zenith and 45 degrees azimuth with respect to face of features. Plots 60 and 62 indicate that with increase in refractive index (plotted along x-axis 64) the total light transmission (plotted along left y-axis 66) decreased while the transmission haze (plotted along right y-axis 68) remained relatively constant. This data indicated that lower refractive index materials yield higher transparency.

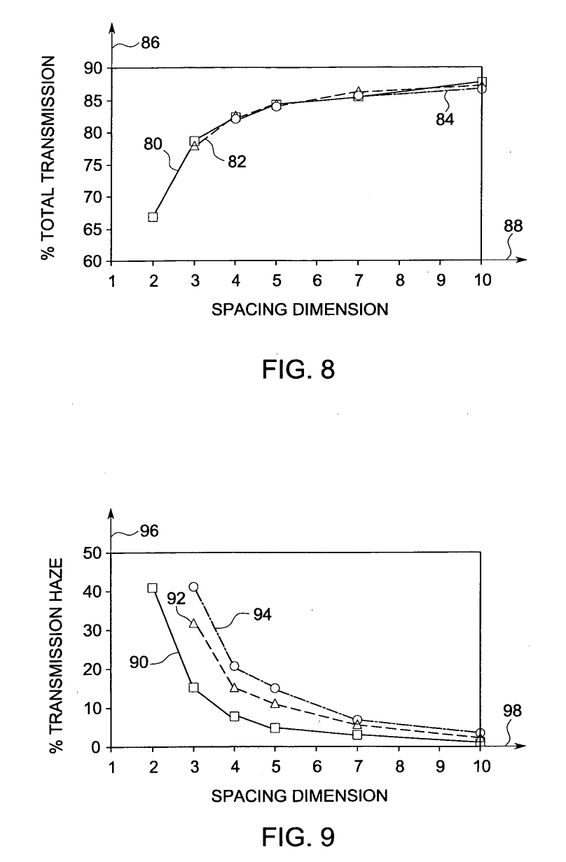

FIG. 7 represents the change in total light transmission (plot 70) and light transmission haze (plot 72) by changing the spacing dimension for square features that have a height of 10 microns, an aspect ratio=1, and a material refractive index of 1.5 for visible light with a wavelength of 550 nm. Sample measurement orientation was at 45 degrees zenith and 45 degrees azimuth with respect to face of features. As the spacing dimension (plotted along x-axis 74) increased, the total transmission (plotted along left y-axis 76) increased and light transmission haze (plotted along right y-axis 78) decreased. This data shows that increase of spacing dimension helps to obtain higher transparency. But, there is a spacing dimension beyond which the contact angle decreases, or the surface looses its superhydrophobicity. Therefore, there is an optimum spacing window within which the surface may be made both superhydrophobic and transparent. FIG. 8 represents the change in total transmission by changing the spacing dimension for square features that have a height of 10 microns, and an aspect ratio=1, 2, and 3 in plots 80, 82, and 84, all with a material refractive index of 1.5 for visible light with a wavelength of 550 nm. Sample measurement orientation was at 45 degrees zenith and 45 degrees azimuth with respect to face of features. The total light transmission (plotted along y-axis 86) increased with increase in spacing dimension (plotted along x-axis 88) and the aspect ratio of the features did not have much influence on the variation.

FIG. 9 represents the change in light transmission haze (plots 90, 92, and 94) by changing the spacing dimension for square features that have a height of 10 microns, and an aspect ratio=1, 2, and 3 respectively, all with a material refractive index of 1.5 for visible light with a wavelength of 550 nm. Sample measurement orientation was at 45 degrees zenith and 45 degrees azimuth with respect to face of features. The light transmission haze (plotted along y-axis 96) decreased with increase in spacing dimension (plotted along x-axis 98) and the aspect ratio of the features had a significant influence on the variation. It is clear that to maximize the transparency, the aspect ratio may be minimized and the spacing dimension may be maximized. However, this condition is not advantageous to obtain superhydrophobicity. Therefore, there is an optimum spacing window within which the surface may be made both superhydrophobic and transparent.

While various embodiments are described herein, it will be appreciated from the specification that various combinations of elements, variations, equivalents, or improvements therein may be made by those skilled in the art, and are still within the scope of the invention.

1. An article comprising a surface portion, the surface portion having a plurality of primary features, wherein the primary features have a median height dimension in the range from about 1 micron to about 500 microns, a median aspect ratio in the range from about 0.5 to about 10, and a median spacing dimension in the range from about 0.5 to about 50 feature width units, and wherein the surface portion comprising the features has a wettability of the surface sufficient to generate, with a reference fluid, a static contact angle of greater than about 120 degrees, and a total transmission of at least about 70% in the visible range of electromagnetic radiation.

2. The article of claim 1, wherein each of the primary features has a cross sectional shape of a parallelogram, as projected on a plane parallel to the surface portion of the article.

3. The article of claim 2, wherein the parallelogram is a rectangle.

4. The article of claim 3, wherein the parallelogram is a square.

5. The article of claim 1, wherein the median height dimension is in the range from about 10 microns to about 100 microns.

6. The article of claim 1, wherein the median aspect ratio is in the range from about 1 to about 3.

7. The article of claim 1, wherein the median spacing dimension is in the range from about 0.5 to about 5 feature width units.

8. The article of claim 1, wherein the median spacing dimension is in the range from about 3 to about 5 feature width units.

9. The article of claim 1, wherein the primary features have a refractive index in the range from about 1.3 to about 2.

10. The article of claim 1, wherein the primary features comprise a polymer.

11. The article of claim 10, wherein the polymer comprises a hydrophobic polymer.

12. The article of claim 11, wherein the hydrophobic polymer comprises a polymer selected from the group consisting of silicone, polyolefin, polyacrylamide, polystyrene, polyester, polyurethane, polyphenylene sulphide, polyvinyl chloride acrylate, fluoropolymers, fluoro-modified polycarbonate, silicone-modified polycarbonate, hydrophobic non-BPA polycarbonate, copolymers thereof, and blends thereof.

13. The article of claim 12, wherein the hydrophobic polymer comprises silicone.

14. The article of claim 12, wherein the hydrophobic polymer comprises a copolymer of polycarbonate and silicone.

15. The article of claim 12, wherein the hydrophobic polymer comprises a fluoro-capped polycarbonate.

16. The article of claim 10, wherein the polymer comprises a hydrophilic polymer, wherein the hydrophilic polymer has a wettability sufficient to generate a contact angle of at least about 70 degrees with water.

17. The article of claim 16, wherein the hydrophilic polymer comprises a polymer selected from the group consisting of polycarbonate, polyimide, polysilazane, polyacrylate, polyurethane, epoxy, polyetherimide, polysulfone, copolymers thereof, and combinations thereof.

18. The article of claim 1, wherein the primary features comprise a ceramic.

19. The article of claim 18, wherein the ceramic comprises at least one material selected from the group consisting of an oxide, a carbide, a boride, a nitride, a fluoride, a selenide, a telluride, a chalcogenide, a sulphide, an oxynitride, and combinations thereof.

20. The article of claim 1, wherein the surface portion comprises a metal.

21. The article of claim 1, wherein the surface portion comprises diamond-like carbon.

22. The article of claim 1, wherein the surface portion comprises a glass.

23. The article of claim 1, wherein at least one primary feature further comprises a plurality of secondary features disposed on the primary feature.

24. The article of claim 23, wherein the secondary features have a largest dimension of less than about 300 nanometers.

25. The article of claim 23, wherein the secondary features have a dimension in the range from about 100 nanometers to about 150 nanometers.

26. The article of claim 23, wherein the secondary features comprise a material selected from the group consisting of a polymer, a ceramic, and a metal.

27. The article of claim 1, wherein the surface portion further comprises a surface energy modification layer.

28. The article of claim 27, wherein the surface energy modification layer comprises a coating disposed over the features.

29. The article of claim 28, wherein the coating comprises at least one material selected from the group consisting of a hydrophobic hard coat, a fluorinated non-polymeric material, a polymer, and combinations thereof.

30. The article claim 1, wherein the article comprises at least a portion of at least one item selected from the group consisting of a window pane, a display screen, a mirror, a medical device, a lens, and a container.

31. An article comprising a surface portion, the surface portion having a plurality of primary features, wherein the primary features have a median height dimension in the range from about 1 micron to about 500 microns, an median aspect ratio in the range from about 0.5 to about 10, a median spacing dimension in the range from about 0.5 to about 50 feature units, and wherein the surface portion comprising the features has a total transmission of at least about 70% in the visible range of electromagnetic radiation.

32. An article comprising a surface portion, the surface portion having a plurality of primary features, wherein the primary features have a median height dimension in the range from about 10 micron to about 100 microns, an median aspect ratio in the range from about 1 to about 3, and a median spacing dimension in the range from about 3 to about 5 feature width units, and wherein the surface portion comprising the features has a wettability of the surface sufficient to generate, with a reference fluid, a static contact angle of greater than about 120 degrees, and a total transmission of at least about 70% in the visible range of electromagnetic radiation.
